(19) United States
(12) Patent Application Publication
(10) Pub. No.: US 2017/0185784 A1
(43) Pub. Date: Jun. 29, 2017

(54) POINT-WISE PROTECTION OF APPLICATION USING RUNTIME AGENT

(71) Applicant: HEWLETT PACKARD ENTERPRISE DEVELOPMENT LP, Houston, TX (US)

(72) Inventors: Matias MADOU, Diegem (BE); Ronald SECHMAN, Alpharetta, GA (US); Sam NG MING SUM, Hong Kong (CN)

(21) Appl. No.: 15/312,644

(22) PCT Filed: May 20, 2014
(86) PCT No.: PCT/US2014/038848

§ 371 Date: Nov. 20, 2016

(51) Int. Cl. G06F 21/57; H04L 29/06; G06F 21/54

(52) U.S. Cl. CPC G06F 21/577; G06F 21/54; H04L 63/1433; G06F 2221/033

(57) ABSTRACT

Example embodiments disclosed herein relate to generating a point-wise protection based capable of being implemented using a runtime agent. Security information including line of code information associated with possible vulnerabilities are processed to determine vulnerability solution recommendations. A vulnerability solution recommendation is presented. The point-wise protection is generated based on a selection input for the vulnerability solution recommendation, where the point-wise protection is capable of being implemented using a runtime agent.

### BACKGROUND

Software security testing is used to identify vulnerabilities in an application such as a Web application. Static Code Analysis is the analysis of computer software that is performed without actually executing programs. Dynamic Analysis is the analysis of computer software performed on executing programs.

### BRIEF DESCRIPTION OF THE DRAWINGS

The following detailed description references the drawings, wherein:

FIG. 1 is a block diagram of a computing system capable of generating a point-wise protection for an application, according to one example;

FIGS. 2 and 3 are block diagrams of computing systems capable of generating a point-wise protection to be implemented by a runtime agent, according to various examples;

FIG. 4 is a flowchart of a method for generating point-wise protection for an application to be implemented by a runtime agent, according to one example; and

FIG. 5 is a block diagram of a computing device capable of generating a point-wise protection based on static code analysis capable of being implemented via a runtime agent, according to one example.

### DETAILED DESCRIPTION

As noted, software security testing of applications can be performed to determine vulnerabilities in an application, such as a web application. Testing can be done to ensure that data used by the web application is protected from being overwritten and/or read, to ensure that the web application stays up, to protect against various attacks, etc.

When a company desires to know how secure a web application the company has in production is or going to be put into production, the company often uses a security testing solution. The company may wish to use a copy of the application in production as an Application to harden (ATH). A reason to use an application in production or an application that is going to be put into production for testing is that the company may desire to test the same code in a manner that modifications to the ATH are not allowed. Using an ATH that is going to be the application in production at a quality assurance stage ensures that the application used in production has been tested. As described herein, hardening an application can be considered the process of securing the application by reducing its surface of vulnerability and/or possible vulnerabilities.

Fixing vulnerabilities that are discovered by software security testing such as static or dynamic security testing can take time. When numerous applications are scanned and numerous vulnerabilities are found within each application, the time to fix the issues outnumbers the time the developers may have to put these applications into production. On top of that, some of these applications are already in production so a fix may be desired in a timely fashion.

Accordingly, various embodiments described herein relate to a fix (e.g., a temporary fix) that may be used to get the vulnerable applications in production in a safe way. Additionally or alternatively, when the applications are already in production, patches (e.g., temporary patches) may be used to make sure the apps are hardened to withstand attacks. The patches can be implemented using a runtime agent executing with the application in production. Further, because the fix can be specific, the whole application may not need to be tested again to implement the fix.

From a high level, the approaches described herein use instrumentation technology to automatically apply the “patches” used to fix the vulnerabilities found by a security analysis tool (e.g., a static analysis tool) in order to create point-wise protections for the problems which can be applied at the code level.

The result file of a security analysis (e.g., a static analysis solution, a dynamic analysis solution, etc.) can be a list of theoretical vulnerabilities in the application. For each issue (potential vulnerability), line of code details can be provided to show where the problem in the code is.

A runtime agent can be used to monitor program points in the application and if necessary, take action when certain behavior is spotted. In this manner, the vulnerabilities determined by the security analysis solution can be converted in a point-wise protection patch for the issue and implemented using the runtime agent. Further, because the runtime agent can run separately and overlay the code of the application, the tested production application can be implemented while having the additional protections. The protections can be specific and thus may not need to be tested with the whole application. In some examples, suggested protections may be tested separately prior to being included as a suggestion.

The runtime agent can be implemented as a Runtime Instrumentation Engine. Runtime instrumentation refers to the ability to modify the program code at runtime (or load time) for monitoring, tracing, debugging, or adding extra functionality to the original program code. Various frameworks offer various approaches to enabling this functionality. For example, the Microsoft .NET® framework can use the ICorProfilierCallback and ICorProfilerCallback2 interfaces to help enable such functionality. Other frameworks can include Java™ WebObjects, web2py, etc. The engine can be in the form of a library or a dynamic-link library (DLL), and can be activated during an early stage of the program initialization to transform any other program code, classes, etc. that are loaded thereafter. The configuration file can instruct the engine as to what should be transformed, intercepted, or monitored.

The result file is analyzed and the locations of possible vulnerabilities can be determined. Particular types of vulnerabilities that may be common may be associated with particular solutions. These solutions (e.g., one or more lines of code to put into the application via the runtime agent) can be provided (e.g., output, presented, emailed, etc.) to a user. The user can provide input (e.g., a selection, writing or modification of code, etc.) to generate a patch executable by the runtime agent. Once the code to either add to or replace executable code of the application is determined, a point-wise patch can be generated. The patch can be sent to be used with one or more applications (e.g., applications of the same type and/or version as the application tested). A runtime agent can use the patch to implement the point-wise protection on the application(s).

A benefit of allowing a user to be able to view and/or edit the added/replacement code is that the user is able to see what the intention of a coder of the application had. For example, if usage of a particular function took in 4 digits to lookup a particular location on a map would not need to be protected as much as usage of the function for looking up something about a user based on their birth date. Accordingly, the context of the code can be useful in determining whether a fix is necessary and/or what the appropriate fix would be.

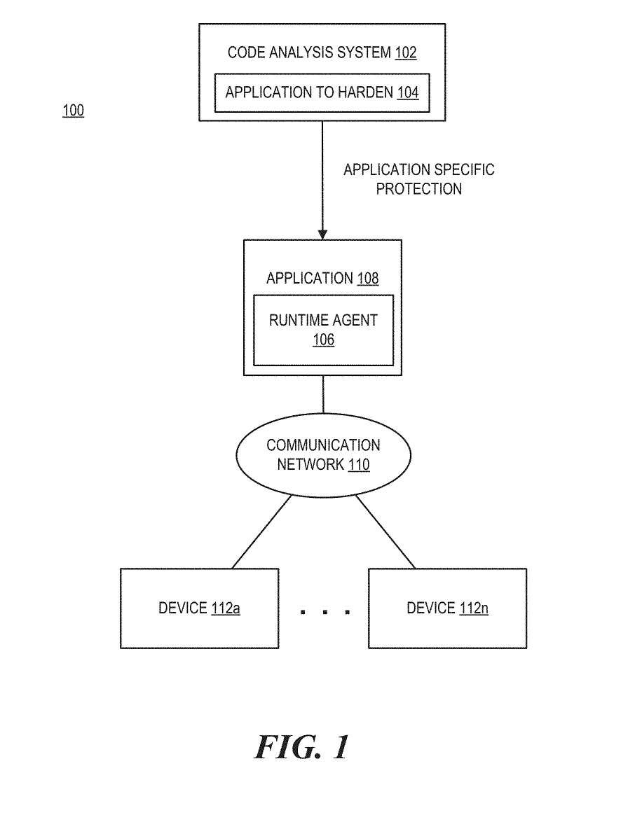

FIG. 1 is a block diagram of a computing system capable of generating a point-wise protection for an application, according to one example. The system 100 can include a code analysis system 102 that can perform analysis on an application to harden (ATH) 104. This can be used to generate a point-wise protection that can be communicated to a runtime agent 106 executing with an application 108. The application 108 can communicate with devices 112a-112n via a communication network 110. In certain examples, the devices 112a-112n are computing devices, such as servers, client computers, desktop computers, mobile computers, etc. Moreover, the code analysis system 102, ATH 104, application 108, and/or runtime agent 106 can be implemented or used via a computing device. In some examples, the devices can be implemented via a processing element, memory, and/or other components.

A code analysis system 102 can perform analysis on the ATH 104. The ATH 104 can be an application, such as a web application. In certain examples, the code analysis system can include a dynamic module, such as a web application scanner. In other examples, the code analysis system 102 can include a static tool, such as a static analysis tool. In some examples, a static analysis tool is an analysis of computer software that is performed without actually executing the computer software. The analysis can be on a version of source code, object code, binary code, etc. The analysis may execute to determine vulnerabilities based on one or more rules or configurations. The result of this can be a data structure (e.g., list) of issues (e.g., potential vulnerabilities) in the application. The issues can include line of code details associated with the potential vulnerability. The list can be output and processed.

The code analysis system 102 can also include a protection generation engine to process the outputted list or data structure. In one example, the potential vulnerabilities can be presented to a user. The presented potential vulnerabilities can be considered vulnerability solution recommendations or recommendations of places in the code to fix vulnerabilities. The presentation may further include more specific solution recommendations such as possible patch recommendations that include replacement code.

In one example, the system can provide the user with an ability to input which of the vulnerability solution recommendations to address. These can be issues that are more important to an organization deploying the application. When the recommendations are being addressed, the more specific solution recommendations can be provided. In one example, the process is semi-automatic (e.g., one or more recommended changes are brought to the attention of the user and the user can select the change). In the semi-automatic case, the user may also be provided an opportunity to edit code to be implemented. The code changes can be turned into a point-wise protection that can be executed by a runtime agent. One or more point-wise protections can be combined into a configuration file that can be implemented by a runtime agent 106 used to protect an application 108. The application 108 can be one that is already in the field and/or an application that is going to be implemented. The application can be based on the application to harden 104. For example, the application 108 may be a compiled version of the ATH 104. As such, it can be an executing instance of the ATH. As noted above, the ATH 104 may be source code, partially compiled, or compiled code.

In some examples, the code analysis system 102 can be provided via the Internet. With this approach, a user can upload their application (e.g., source code, partial source code, binary code, etc.) to the code analysis system 102 and receive application specific protection(s) that can be implemented using a runtime agent 106.

The communication network 110 can use wired communications, wireless communications, or combinations thereof. Further, the communication network 110 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 110 can be in the form of a direct network link between devices. Various communications structures and infrastructure can be utilized to implement the communication network(s).

By way of example, the devices and systems communicate with each other and other components with access to the communication network 110 via a communication protocol or multiple protocols. A protocol can be a set of rules that defines how nodes of the communication network 110 interact with other nodes. Further, communications between network nodes can be implemented by exchanging discrete packets of data or sending messages. Packets can include header information associated with a protocol (e.g., information on the location of the network node(s) to contact) as well as payload information. Network interface cards of the devices/systems may be used for communication.

In one example, a web application is an application that is accessed over a network such as the Internet or an intranet. In certain examples, the web application can run on J2EE Application Server or be an ASP or ASP.NET web application. The frameworks used can use various types of features. In some examples, for example, in the .NET framework, standard Authentication and Authorization frameworks can be used. The approaches for authorization checks being made can be monitored for each type of framework supported. These checks may be useful in securing against particular vulnerabilities.

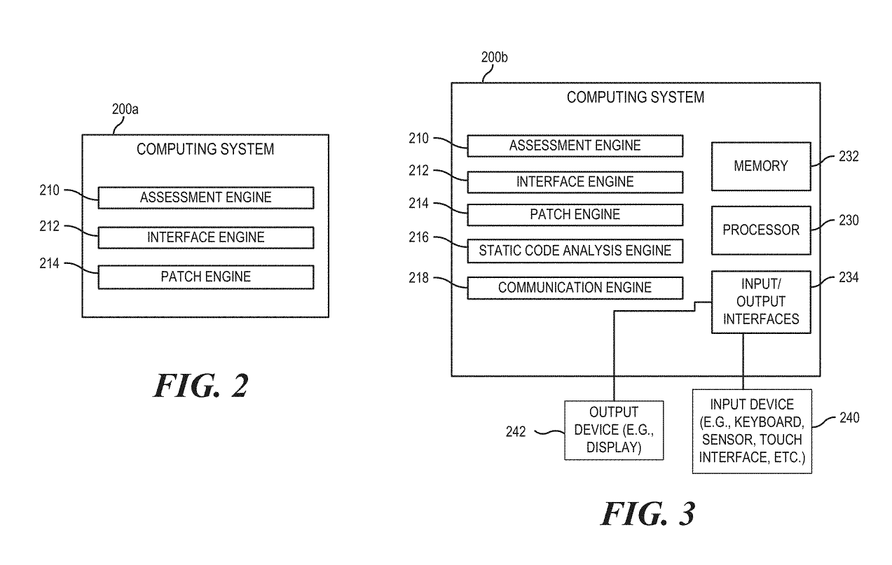

FIGS. 2 and 3 are block diagrams of computing systems capable of generating a point-wise protection to be implemented by a runtime agent, according to various examples. Computing systems 200a, 200b include components that can be utilized to generate a point-wise protection capable of being implemented using a runtime agent. The respective computing systems 200a, 200b may be a notebook computer, a desktop computer, a tablet computing device, a wireless device, a server, a workstation, or any other computing device that is capable of performing the functionality described herein.

In one example, computing system 200a may include an assessment engine 210, an interface engine 212, and a patch engine 214. In another example, a computing system 200b may further include a static code analysis engine 216, a communication engine, one or more processors 230, memory 232, other input/output interfaces 234, etc.

The engines 210, 212, 214, 216 include hardware and/or combinations of hardware and programming to perform functions provided herein. Moreover, the modules (not shown) can include programing functions and/or combinations of programming functions to be executed by hardware as provided herein. When discussing the engines and modules, it is noted that functionality attributed to an engine can also be attributed to the corresponding module and vice versa. Moreover, functionality attributed to a particular module and/or engine may also be implemented using another module and/or engine.

An assessment engine 210 can be used to process security information including possible vulnerabilities of an application to determine respective vulnerability solution recommendations for the possible vulnerabilities. The security information can include the possible vulnerabilities as well as line of code information associated with the respective possible vulnerabilities. In certain examples, the security information can be received from a security code analysis tool. As noted above, security code analysis can include various types of static code analysis and/or dynamic code analysis.

In one example, the computing system can receive code via a communication engine 218. The computing system 200 can receive code in other ways as well. In certain examples, the code can be source code, binary code, assembly code, partially processed code, combinations thereof, etc. Code analysis can be performed on the code. For example, a static code analysis engine 216 can be used to determine the possible vulnerabilities and the respective line of code information associated with the possible vulnerabilities from statically analyzing code of the application. Examples of vulnerabilities that can be detected include cross-site scripting, a race condition: singleton member field, insecure randomness, Axis 2 Misconfiguration: Debug Information, remote code execution, SQL injection, format string vulnerabilities, username enumeration, etc.

The interface engine 212 can be used to present at least one of the respective vulnerability solution recommendations and to receive selection input for the one vulnerability solution recommendation. In some examples, the vulnerability solution recommendations can include a type of vulnerability detected and a location of the vulnerability. In other examples, the vulnerability solution recommendations can further include one or more approaches to fixing or mitigating the potential vulnerability. Table 1 includes some examples of possible patches for vulnerabilities.

TABLE 1

| Vulnerabilities | Possible Patch |
|---|---|
| Cross-site Scripting | Install an input validation filter and may or |
| | may not require the user to provide the |
| | validation pattern |
| Race Condition: Singleton | Instrument the code to automatically lock |
| Member Field | the race object before access |
| Insecure Randomness | Instrument the code to use secure random |
| | number generator instead |
| Axis 2 Misconfiguration: | Instrument the code to disable debug flag |
| Debug Information | |

The user can select the vulnerability. The user can then be presented with an opportunity to see the location(s) of the selected vulnerability and/or one or more possible patches. In one example, the user can enter code to replace code determined to be a vulnerability. In another example, the patch engine 214 can provide the possible fix. In a further example, the user can be presented the current code as well as one or more possible fix as options. The user can also be provided the ability to change the code. The patch engine 214 can be used to generate respective point-wise protection based on the selection input and the processed security information (e.g., line of code information). The point-wise protection can be capable of being implemented using a runtime agent to protect a second application corresponding to the application being tested. For example, the second application may be an application that is currently in production or is being put into use. In some examples, the second application and the application can be of a same version number. This can include the same version of the application and/or a portion of the code of the application.

In some examples, the point-wise protection can be in the form of an instruction to a runtime agent to intercept execution of the second application and run replacement code instead. Thus, the point-wise protection can functionally replace code of at least a portion of the application. In this example, the code of the actual application is not replaced, but functionally replaced because the code of the application is not executed, but instead, the runtime agent executes the protection instead. In some examples, the point-wise protection may add some code to be executed (e.g., via adding a security check). In some examples, multiple points may be intercepted to protect against a vulnerability.

Implementation of the point-wise protection can cause the runtime agent to execute the point-wise protection when a point of a code of the second application is reached that is associated with the vulnerability associated with the fix.

In one example, implementation of the point-wise protection can include adding a security check. With this type of protection, the runtime agent can add an authorization check or some other type of analysis of a user, a machine, etc. before allowing certain code to be executed. This can be based on added code and/or use of new library or currently used library of the application. In one example, if the security check is failed, a security action is taken via the runtime agent. In one example, the security action can include denying execution of the code associated with the vulnerability. In another example, the security action may be to point a user of the application to a web page that shows an error.

A processor 230, such as a central processing unit (CPU) or a microprocessor suitable for retrieval and execution of instructions and/or electronic circuits can be configured to perform the functionality of any of the modules or engines 210, 212, 214, 216, 218 described herein. In certain scenarios, instructions and/or other information, such as a database of potential patches, can be included in memory 232 or other memory. Input/output interfaces 234 may additionally be provided by the computing device 200b. For example, input devices 240, such as a keyboard, a sensor, a touch interface, a mouse, a microphone, etc. can be utilized to receive input from an environment surrounding the computing device 200b. Further, an output device 242, such as a display, can be utilized to present information to users. Examples of output devices include speakers, display devices, amplifiers, etc. Moreover, in certain embodiments, some components can be utilized to implement functionality of other components described herein. Input/output devices such as communication devices like network communication devices or wireless devices can also be considered devices capable of using the input/output interfaces 234. The interface engine 212 can use one or more of the input/output interfaces 234.

Each of the modules (not shown) may include, for example, hardware devices including electronic circuitry for implementing the functionality described herein. In addition or as an alternative, each module may be implemented as a series of instructions encoded on a machine-readable storage medium of computing system 200 and executable by processor 230. It should be noted that, in some embodiments, some modules are implemented as hardware devices, while other modules are implemented as executable instructions. Moreover, in certain examples, engines/modules of the computing system can be implemented in a single device and/or in multiple devices.

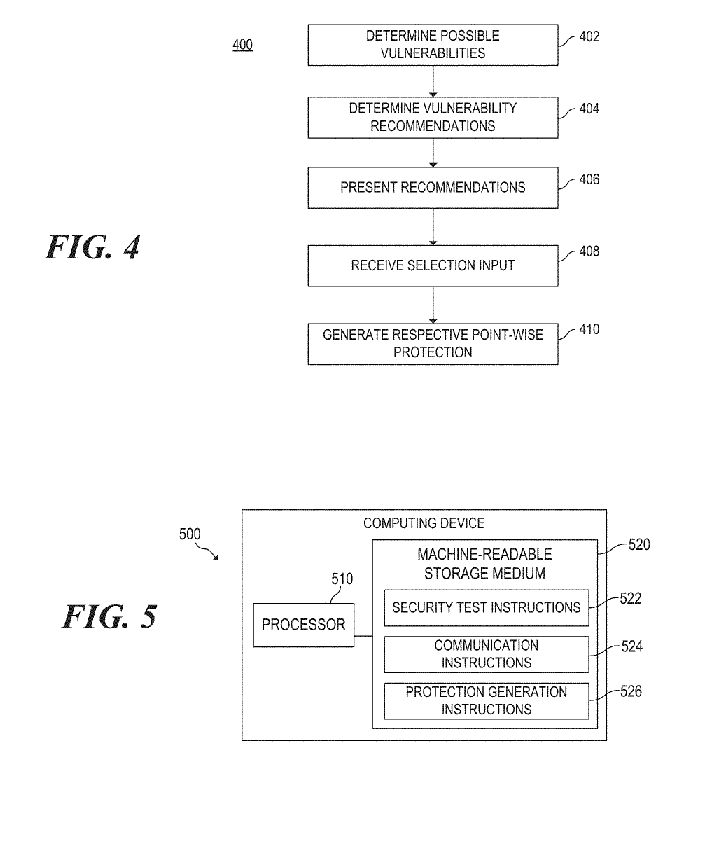

FIG. 4 is a flowchart of a method for generating point-wise protection for an application to be implemented by a runtime agent, according to one example. FIG. 5 is a block diagram of a computing device capable of generating a point-wise protection based on static code analysis capable of being implemented via a runtime agent, according to one example.

Although execution of method 400 is described below with reference to computing device 500, other suitable components for execution of method 400 can be utilized (e.g., computing system 200). Additionally, the components for executing the method 400 may be spread among multiple devices. Method 400 may be implemented in the form of executable instructions stored on a machine-readable storage medium, such as storage medium 520, and/or in the form of electronic circuitry. In some examples, the computing device 500 may include a processor 510 and machine-readable storage medium 520 including security test instructions 522, communication instructions 524, and protection generation instructions 526.

Communication instructions 524 can be executed to send and receive information. For example, the computing device 500 can receive code to analyze and send information (e.g., code analysis, point-wise protections to be implemented via a runtime agent, etc.). In some examples, a web application can be provided to receive code and provide information. As noted, code received can be source code or other formats of code of an application to harden (ATH).

At 402, security test instructions 522 can be implemented to determine possible vulnerabilities and respective line of code information about the possible vulnerabilities. This can be via, for example, statically analyzing code of the ATH. Line of code information can include a location of the code and/or the actual code (e.g., source code, compiled code, etc.). The information may also include information about a type of the vulnerability. For example, the information may say that the vulnerability is in a particular category (e.g., cross-site scripting) and/or one or more subcategories (e.g., for more specific vulnerabilities). This can be based on various types of classification.

At 404, protection generation instructions 526 can be executed by the processor 510 to determine vulnerability solution recommendations for one or more of the vulnerabilities. In some examples, the vulnerability solution recommendation can point to a location in the code where the issue is present and provide information about the vulnerability (e.g., name, category, classification, etc.).

In some examples, a data structure or database can include a mapping of the identified vulnerabilities (e.g., based on classification or categorization of the vulnerabilities) to one or more implementable possible solutions. For example, a cross-site scripting issue with a particular framework may be mapped to one or more possible ways of fixing or containing the issue. Moreover, the possible solutions can be prioritized. Implementable possible solutions can include a recommendation to add and/or replace at least some of the code of the ATH with code to fix/mitigate the issue.

At 406, communication instructions 524 can be used to present the respective vulnerability solution recommendations. For example, a presentation can include a function of code (e.g., .in foo.java), the location of the code (e.g., line 20), a type of vulnerability/categorization, a recommended fix (e.g., there should be an additional check), or combinations thereof. The recommended fix can also be more specific (e.g., what type or types of checks to include, code to include, etc.).

At 408, the communication instructions 524 can be executed to receive selection input for one of the vulnerability solution recommendations. The selection input may include a selection of one or more implementable possible solution and/or selection of one of the identified vulnerabilities. The selection can prompt showing of the vulnerability and/or implementable solution with the vulnerability. Moreover, a prompt can be provided to allow a user to input code into the area. In some examples, the vulnerability may have multiple code sections that are shown and allowed to be fixed.

At 410, the protection generation instructions 526 can be executed to generate respective point-wise protection based on the selection input and the vulnerability solution recommendation. As noted above, the point-wise protection can be capable of being implemented using a runtime agent to protect a second application corresponding to the ATH. In some examples, the second application is of a same version as the ATH.

Further, implementation of the point-wise protection can cause the runtime agent to execute the point-wise protection when a point of a code of the second application is reached that is associated with the possible vulnerability. Moreover, the implementation of the point-wise protection can include adding a security check. The security check can be selected and/or added in response to presentation of the possible vulnerabilities. In one example, implementation of the point-wise protection functionally replaces at least part of the code of the second application and executes protection code by the runtime agent.

The protection generated can include instructions to the runtime agent about what to do and when. For example, the protection can instruct the runtime agent to break the code execution of the application when a certain point is reached and perform a virtual patch (e.g., the protection). An end mechanism can also be used. For example, if an additional check is implemented, the code can return to the point it was broken if the additional check is successful. If the additional check is not successful, another action can be taken, for example, killing execution of the application, stopping the application, returning an unauthorized or other error, noting the check and continuing, etc.

The computing device 500 includes, for example, a processor 510, and a machine-readable storage medium 520 including instructions 522, 524, 526 for generating a point-wise protection capable of being executed using a runtime agent. Computing device 500 may be, for example, a notebook computer, a slate computing device, a portable reading device, a server, a workstation, a mobile phone, or any other computing device capable of providing the functionality described herein.

Processor 510 may be, at least one central processing unit (CPU), at least one semiconductor-based microprocessor, at least one graphics processing unit (GPU), other hardware devices suitable for retrieval and execution of instructions stored in machine-readable storage medium 520, or combinations thereof. For example, the processor 510 may include multiple cores on a chip, include multiple cores across multiple chips, multiple cores across multiple devices (e.g., if the computing device 500 includes multiple node devices), or combinations thereof. Processor 510 may fetch, decode, and execute instructions 522, 524, 526 to implement method 400. As an alternative or in addition to retrieving and executing instructions, processor 510 may include at least one integrated circuit (IC), other control logic, other electronic circuits, or combinations thereof that include a number of electronic components for performing the functionality of instructions 522, 524, 526.

Machine-readable storage medium 520 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 520 may be encoded with a series of executable instructions for generating a point-wise protection that is executable by a runtime agent.

What is claimed is:

1. A computing system comprising:
an assessment engine to process security information including possible vulnerabilities of an application to determine respective vulnerability solution recommendations for the possible vulnerabilities, wherein the security information further includes the possible vulnerabilities as well as line of code information associated with the respective possible vulnerabilities;
an interface engine to present at least one of the respective vulnerability solution recommendations and to receive selection input for the one vulnerability solution recommendation; and
a patch engine to generate respective point-wise protection based on the selection input and the processed security information capable of being implemented using a runtime agent to protect a second application corresponding to the application.

2. The computing system of claim 1,
wherein implementation of the point-wise protection causes the runtime agent to execute the point-wise protection when a point of a code of the second application is reached that is associated with one of the possible vulnerabilities corresponding to the at least one of the respective vulnerability solutions.

3. The computing system of claim 2,
wherein implementation of the point-wise protection includes adding a security check.

4. The computing system of claim 3,
wherein if the security check is failed, a security action is taken via the runtime agent.

5. The computing system of claim 4,
wherein implementation of the point-wise protection functionally replaces at least part of the code of the second application.

6. The computing system of claim 1, further comprising:
a static code analysis engine to determine the possible vulnerabilities and the respective line of code information from statically analyzing code of the application.

7. The computing system of claim 6, further comprising:
a communication engine to receive the code via a web interface.

8. The computing system of claim 1, wherein the point-wise protection further includes code entered via the interface engine.

9. A non-transitory machine-readable storage medium storing instructions that, if executed by at least one processor of a computing system, cause the computing system to:
determine possible vulnerabilities and respective line of code information about the possible vulnerabilities by statically analyzing code of a first application;
determine at least one vulnerability solution recommendation for at least one of the possible vulnerabilities;
present the at least one respective vulnerability solution recommendation;
receive selection input for one of the at least one vulnerability solution recommendations; and
generate respective point-wise protection based on the selection input and the at least one respective vulnerability solution recommendation capable of being implemented using a runtime agent to protect a second application corresponding to the application.

10. The non-transitory machine-readable storage medium of claim 9, wherein the second application is of a same version as the first application.

11. The non-transitory machine-readable storage medium of claim 9, wherein implementation of the point-wise protection causes the runtime agent to execute the point-wise protection when a point of a code of the second application is reached that is associated with the point-wise at least one possible vulnerability.

12. The non-transitory machine-readable storage medium of claim 11,
wherein implementation of the point-wise protection includes adding a security check.

13. The non-transitory machine-readable storage medium of claim 11,
wherein implementation of the point-wise protection functionally replaces at least part of the code of the second application and executes protection code by the runtime agent.

14. A method comprising:
determining vulnerabilities and respective line of code information about the vulnerabilities by statically analyzing code of a first application;
determining at least one vulnerability solution recommendation for at least one of the vulnerabilities;
presenting the at least one respective vulnerability solution recommendation;
receiving selection input for one of the at least one vulnerability solution recommendation; and
generating a respective point-wise protection based on the selection input and the at least one respective vulnerability solution recommendation,
wherein the point-wise protection is capable of being executed by a runtime agent configured to be used with a second application of a same version as the first application, and
wherein the point-wise protection is to execute by the runtime agent when a point of a code of the second application is reached that is associated with the at least one vulnerability.

15. A method of claim 14, wherein implementation of the point-wise protection functionally replaces at least part of the code of the second application.
